(19) United States
(12) Patent Application Publication
(10) Pub. No.: US 2020/0236184 A1
(43) Pub. Date: Jul. 23, 2020

(54) METHOD, ELECTRONIC DEVICE AND COMPUTER STORAGE MEDIUM FOR PUSHING INFORMATION

(71) Applicant: ZHANGYUE TECHNOLOGY CO., LTD., Beijing (CN)

(72) Inventors: Jingtao TIAN, Beijing (CN); Fang WANG, Beijing (CN)

(21) Appl. No.: 16/648,657

(22) PCT Filed: Mar. 26, 2018
(86) PCT No.: PCT/CN2018/080435

§ 371 Date: Mar. 18, 2020

(30) Foreign Application Priority Data
Sep. 21, 2017 (CN) 201710860863.X

(51) Int. Cl. H04L 29/08

(52) U.S. Cl. CPC H04L 67/26

(57) ABSTRACT

Disclosed in the present disclosure are a method, an electronic device and a non-volatile computer-readable storage medium for pushing information. The method comprises: determining attribute information associated with a user based on acquiring a user identification; determining an attribute category corresponding to the attribute information, and determining a classification of information among a plurality of classifications of information to be pushed based on the attribute category, wherein the classification of information matches the attribute category; analyzing attribute data included in the attribute information and obtaining an analysis result, and determining a content among a plurality of contents included in the classification of information based on the analysis result, wherein the content matches the analysis result; and pushing the content to a user terminal device corresponding to the user identification.

### CROSS REFERENCE TO RELATED APPLICATION

This application is based upon and claims priority to Chinese Patent Application No. 201710860863.X, titled “METHOD, ELECTRONIC DEVICE AND COMPUTER STORAGE MEDIUM FOR PUSHING INFORMATION,” filed with the Chinese Patent Office on Sep. 21, 2017, the entire contents of which are incorporated herein by reference.

### TECHNICAL FIELD

The present disclosure relates to the field of computers, and in particular to a method for pushing information, an electronic device and a non-volatile computer-readable storage medium.

### BACKGROUND

At present, when user need to get information, many websites or APPs will push various types of information content to users. In order to increase the interest and entertainment of a pushing process, a pushing manner in the pushing process usually will also take the form of a game such as using a turntable to extract discount manner or randomly scrolling to extract preferential information or the like. The above pushing method can not only push certain preferential information to users but also further increase the users' attention.

However, the inventor found that at least the following problems exist in the prior art: when information is pushed to users in the above manner, the users' use rate for the pushed preferential information is low. The reason is that, due to the limited types of preferential information to be pushed in spite of the huge number of users, one preferential information is often pushed to a plurality of users, whereas for each user, preferential information acquired by that user often does not match that user's actual needs. As a result, upon acquisition of preferential information, all the users usually will choose to discard the acquired preferential information. This not only reduces the effectiveness of the information pushing process but also will further reduce the user experience and thereby also reduce the users' attention, thus making the beneficial effects of the whole information pushing process greatly reduced.

### SUMMARY

In view of the above problems, the present disclosure is proposed in order to provide a method for pushing information, an electronic device and a non-volatile computer-readable storage medium that overcome the above problems or at least partially solve the above problems. According to an embodiment of the present disclosure, a method for pushing information is provided, comprising: determining attribute information associated with a user based on acquiring a user identification; determining an attribute category corresponding to the attribute information, and determining a classification of information among a plurality of classifications of information to be pushed based on the attribute category, wherein the classification of information matches the attribute category; analyzing attribute data included in the attribute information and obtaining an analysis result, and determining a content among a plurality of contents included in the classification of information based on the analysis result, wherein the content matches the analysis result; and pushing the content to a user terminal device corresponding to the user identification.

According to another embodiment of the present disclosure, an electronic device is provided, comprising: at least one processor; and at least one memory, the at least one memory storing executable instructions that upon execution cause the at least one processor to perform operations, the operations comprising: determining attribute information associated with a user based on acquiring a user identification; determining an attribute category corresponding to the attribute information, and determining a classification of information among a plurality of classifications of information to be pushed based on the attribute category, wherein the classification of information matches the attribute category; analyzing attribute data included in the attribute information and obtaining an analysis result, and determining a content among a plurality of contents included in the classification of information based on the analysis result, wherein the content matches the analysis result; and pushing the content to a user terminal device corresponding to the user identification.

According to still another embodiment of the present disclosure, a non-volatile computer-readable storage medium storing computer-readable instructions that upon execution by a processor cause the processor to: determine attribute information associated with a user based on acquiring a user identification; determine an attribute category corresponding to the attribute information, and determine a classification of information among a plurality of classifications of information to be pushed based on the attribute category, wherein the classification of information matches the attribute category; analyze attribute data included in the attribute information and obtain an analysis result, and determine a content among a plurality of contents included in the classification of information based on the analysis result, wherein the content matches the analysis result; and push the content to a user terminal device corresponding to the user identification.

According to yet another embodiment of the present disclosure, a computer program product comprising a computing program stored on the above non-volatile computer-readable storage medium is further provided.

In the method for pushing information, the electronic device and the non-volatile computer-readable storage medium provided by the present disclosure, determining attribute information associated with a user based on acquiring a user identification, to further determine an attribute category corresponding to the attribute information, and determine a classification of information among a plurality of classifications of information to be pushed based on the attribute category, then to analyze attribute data included in the attribute information and obtain an analysis result, and determine a content among a plurality of contents included in the classification of information based on the analysis result, wherein the content matches the analysis result, and finally to push the content to a user terminal device corresponding to the user identification. Accordingly, the present disclosure can effectively classify users and content, and further establish a corresponding relationship between the classified users and content, so as to push a classification of information to a user who matches the classification of information, so that the information pushing is more accurate and customized to the user, thus ensuring the content pushed to the user to meet the user's current needs, and making the information pushing more effective.

The above description is only an overview of the present disclosure. In order to enable the technical means of the present disclosure to be more clear, it can be implemented in accordance with the contents of the description, and in order to make the present disclosure more apparent and comprehensible, specific implementations of the present disclosure will be enumerated below.

### BRIEF DESCRIPTION OF THE DRAWINGS

By reading the specific description of preferred implementations below, various other advantages and benefits will become more apparent and clear for those ordinarily skilled in the art. The drawings are only for the purpose of illustrating preferred embodiments and are not to be considered as limiting the present disclosure. Moreover, the same components are denoted with the same reference signs throughout the drawings, in which:

FIG. 1 shows a flow chart of a method for pushing information provided by Embodiment 1 of the present disclosure;

FIG. 2 shows a flow chart of a method for pushing information provided by Embodiment 2 of the present disclosure; and

FIG. 3 shows a structural schematic diagram of an electronic device according to Embodiment 4 of the present disclosure.

### DETAILED DESCRIPTION

Hereinafter, exemplary embodiments of the present disclosure will be described in more detail with reference to the accompanying drawings. Although exemplary embodiments of the present disclosure are shown in the drawings, it should be understood that the present disclosure can be implemented in various forms and should not be limited by the embodiments set forth herein. On the contrary, these embodiments are provided to enable a more thorough understanding of the present disclosure, and to fully convey the scope of the present disclosure to those skilled in the art.

The present disclosure can solve the problem that: when information is pushed in the manner of randomly extracting push information, the users' use rate for the pushed content is low, thereby causing the effectiveness of content pushing to be greatly reduced. The present disclosure can effectively classify attributes and content, thereby pushing push content of a specific category to a user with a specific attribute, so that the content pushing is more accurate and customized to the user, ensuring the information pushed to the user to match the user's current needs, thus making the content pushing more effective.

### Embodiment 1

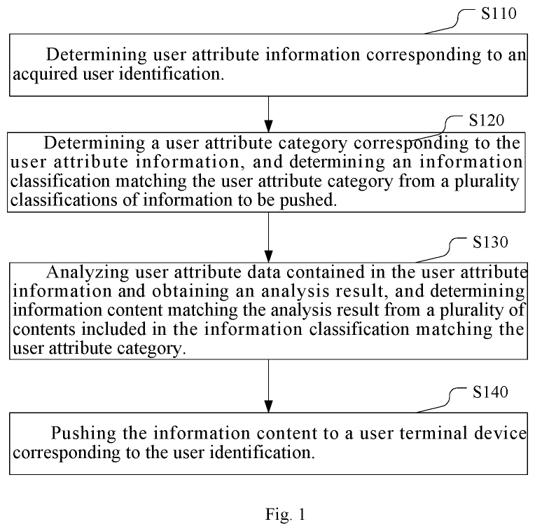

FIG. 1 shows a flow chart of a method for pushing information provided by Embodiment 1 of the present disclosure. As shown in FIG. 1, the method comprises the following steps:

Step S110: Determine attribute information associated with a user based on acquiring a user identification.

Wherein, the user identification is a unique information for identifying a user, such as a user name, a user registration account and the like. Each user identification has attribute information associated with each user, for example, the basic attribute information includes the user's age, gender and the like, or historical behavior attribute information such as historical operation browsing history and the like during the user's use of a website or an APP, or consumption attribute information related to user consumption such as the user's account balance, historical bill, consumption type statistics and the like, etc. In specific implementation, the attribute information includes the various types of information listed above, and the present disclosure does not limit the type of the user attribute information.

Wherein, the attribute information may either comprise only one information or comprise a plurality of information, and the present disclosure does not limit this. Taking an electronic book APP as an example, attribute information may comprise at least one of a balance, a recharge frequency, a recharge amount, a consumption frequency, a consumption amount, a reading duration, a number of participation in discount sales, and information content that has been pushed. Of course, it can be understood that in specific implementation, the user attribute information include, but are not limited to, the above information. Those skilled person in the art can also set the attribute information other than the above information according to actual needs, and the present disclosure does not limit this.

In specific implementation, a triggering condition for this step may be set by a skilled person in the art according to actual situations. For example, in response to receiving a request for pushing messages, acquire a user identification included in the request for pushing messages and determine the attribute information corresponding to the user identification, wherein the request for pushing messages is trigger by the user via a preset interface; or in response to determining a behavior of a user meets a predetermined condition for pushing information, acquire a user identification and determining the attribute information corresponding to the user identification, and so on. The present disclosure does not limit the triggering condition for this step.

Step S120: Determine an attribute category corresponding to the attribute information, and determine a classification of information among a plurality of classifications of information to be pushed based on the attribute category, wherein the classification of information matches the attribute category.

Specifically, there may be various determination manners of the attribute category. When the attribute information only includes one type of information, the information can be divided according to actual situations, and the attribute category can be determined according to a division result. Specifically, the information can be divided into a plurality of different information ranges, with each information range corresponding to one attribute category. Taking the balance as an example, when the attribute information only includes the balance, different balance amounts can be divided, and each balance range can be made to correspond to one user attribute category, thereby determining the attribute category corresponding to the attribute information. In specific implementation, the above manner of dividing the information can be set by the skilled person in the art according to actual situations, and the present disclosure does not limit this.

When the attribute information includes a plurality of types of information, each type of information can be divided according to actual situations to obtain division results, then each division results of different types of information can be combined randomly or freely, and the attribute category can be determined according to a combination result. For example, each information can be divided into a plurality of different types of information range, an information range of the current attribute information in each type of information can be determined, and then information ranges in different types of information can be selected for combination, with each combination result corresponding to one attribute category. Wherein, the above division manner and combination manner of the information ranges can be set by a skilled person in the art according to actual situations, and the present disclosure does not limit this.

Specifically, a plurality of classifications of information to be pushed can be set by a skilled person in the art according to actual situations, and the present disclosure does not limit this. Wherein, for different websites and APPs, the plurality of classifications of information to be pushed are also different correspondingly. Taking an electronic book APP as an example, the plurality of classifications of information to be pushed may comprise at least one of: a book information classification, a points information classification, a physical item information classification, an electronic coupon information classification, a welfare card information classification, a recharge preferential information classification, an activity information classification, or a reading authority information classification, etc. It can be understood that, for the electronic book APP, the above-listed plurality of classifications of information to be pushed are also only exemplary. In specific implementation, a skilled person in the art can also set the plurality of classifications of information to be pushed in the electronic book APP to other classifications of information than the above-listed information classification according to actual situations, and the present disclosure does not limit this.

Finally, determine the classification of information that matches the attribute category based on a first predetermined mapping table, wherein the first predetermined mapping table stores a corresponding relationship between each attribute category and each classification of information. In specific implementation, the corresponding relationship in the above category mapping relationship can be set by those skilled in the art according to actual situations, and the present disclosure does not limit this.

Step S130: Analyze attribute data included in the attribute information, and obtain an analysis result, and determine a content among a plurality of contents included in the classification of information based on the analysis result, wherein the content matches the analysis result.

Specifically, for the attribute data included in the user attribute information, set a range of attribute data corresponding to each content among the plurality of contents contained in each classification of information, wherein specific range values corresponding to the above range can be set by those skilled in the art according to actual situations, and the present disclosure does not limit this. The information content contained in the information classification matching the attribute category is further classified and divided in advance, and the above information is further divided to a plurality of information classification. Then, a second predetermined mapping table is configured to store a plurality of contents contained in each classification of information and a range of attribute data corresponding to each content among the plurality of contents contained in each classification of information, wherein the second predetermined mapping table can be set by those skilled person in the art according to actual situations, and the present disclosure does not limit this.

In this step, a range corresponding to the attribute data is determined by analyzing the attribute data contained in the attribute information, and then information content matching the analysis result is selected among the information classification matching the attribute category according to the above determined data range and the second predetermined mapping table. In specific implementation, a specific analysis manner for analyzing the attribute information can be set by those skilled person in the art according to actual situations, and the present disclosure does not limit this.

Step S140: Push the content to a user terminal device corresponding to the user identification.

Specifically, in this step, the content matching the analysis result in step S130 is pushed to the user terminal device corresponding to the user identification. The user terminal device can be a smartphone, a PAD, a table PC and so on.

In the method for pushing information provided by the present disclosure, it can determine attribute information associated with a user based on acquiring a user identification, to further determine an attribute category corresponding to the attribute information, and determine a classification of information among a plurality of classifications of information to be pushed based on the attribute category, then to analyze attribute data included in the attribute information and obtain an analysis result, and determine a content among a plurality of contents included in the classification of information based on the analysis result, wherein the content matches the analysis result; and finally to push the content to a user terminal device corresponding to the user identification. Accordingly, the present disclosure can effectively classify users and content, and further establish a corresponding relationship between the classified users and content, so as to push a classification of information to a user who matches the classification of information, so that the information pushing is more accurate and customized to the user, thus ensuring the content pushed to the user to meet the user's current needs, and making the information pushing more effective.

### Embodiment 2

FIG. 2 shows a flow chart of a method for pushing information provided by Embodiment 2 of the present disclosure. In this embodiment, description is made by taking an electronic book application as an example. Those skilled person in the art can understand that the present disclosure can also be applied to other various types of applications. As shown in FIG. 2, the method comprises the following steps:

Step S210: Determine user attribute information associated with a user based on acquiring a user identification.

Wherein, there may be a plurality of triggering conditions for this step. For example, in response to receiving a request for pushing messages, acquire a user identification included in the request for pushing messages and determine the attribute information corresponding to the user identification, wherein the request for pushing messages is trigger by the user via a preset interface; or in response to determining a behavior of a user meets a predetermined condition for pushing information, acquire a user identification and determining the attribute information corresponding to the user identification. Wherein, the above two triggering conditions may be used either individually or in combination, and the present disclosure does not limit this. Moreover, the above preset interface may be a lottery button, a mobile phone shaking button and the like. In specific implementation, the present disclosure does not limit the specific setting form of the preset interface. The predetermined condition for pushing information comprises at least one of a user reads up to an electronic book chapter with a reading abandonment probability greater than a preset threshold, a user reading duration exceeds a preset reading duration, a user reading chapter reaches a preset chapter, and so on. In specific implementation, the above preset threshold and preset reading duration can be set by those skilled person in the art according to actual situations, and the present disclosure does not limit this. Of course, it can be understood that those skilled person in the art can also set the trigger condition to other modes than the above two modes according to actual situations, and the present disclosure does not limit this.

Specifically, in this step, the user identification is a unique information for identifying the user, such as a user name, a user registration account and the like. Each user identification has attribute information associated with each user. Wherein, the attribute information may either comprise one type of information or comprise a plurality of types of information, and the present disclosure does not limit this. In this embodiment, the attribute information includes at least one of a balance, a recharge frequency, a recharge amount, a consumption frequency, a consumption amount, a reading duration, a number of participation in activities, or information content that has been pushed. Of course, it can be understood that in specific implementation, the type of attribute information is not limited to the above information types. Those skilled person in the art can also set the attribute information according to actual needs, and the present disclosure does not limit this.

Step S220: Determine an attribute category corresponding to the attribute information, and determine a classification of information among a plurality of classifications of information to be pushed based on the attribute category, wherein the classification of information matches the attribute category.

Specifically, there may be various manners to determinate the attribute category. Wherein, in this embodiment, the attribute information associated with the user identification comprises a plurality of information, and accordingly the process of determining a attribute category corresponding to the attribute information may be as follows: first, user attribute subcategory corresponding to each attribute information is determined, respectively. In specific implementation, each attribute information can be divided into a plurality of categories, and accordingly each category corresponds to one attribute subcategory. Wherein, there may be various manners for dividing each attribute information, and the present disclosure does not limit this. Taking the attribute information of the balance and the recharge frequency as an example, in the balance, a plurality of attribute subcategories corresponding to the attribute information of the balance can be determined according to the size of a balance quota. For example, when the balance amount is less than 10, a attribute subcategory corresponding to the attribute information of the balance is determined as a first attribute subcategory; when the balance amount is between 10-50 (including 10 and 50), a attribute subcategory corresponding to the attribute information of the balance is determined as a second attribute subcategory; when the balance amount is greater than 50, a attribute subcategory corresponding to the attribute information of the balance is determined as a third attribute subcategory, and so on. In the recharge frequency, preset one or more recharge frequency thresholds, and a plurality of attribute subcategories corresponding to the attribute information of the recharge frequency can be determined by judging whether the user recharge frequency is greater than the above recharge frequency threshold. For example, if a recharge frequency threshold is set to 0.3 times/day, when the user recharge frequency is higher than 0.3 times/day, a attribute subcategory corresponding to the attribute information of the recharge frequency is determined as a first attribute subcategory (corresponding to high-frequency recharge users); when the recharge frequency is less than or equal to 0.3 times/day, a attribute subcategory corresponding to the attribute information of the recharge frequency is determined as a second attribute subcategory (corresponding to low-frequency recharge users), and so on. Similarly, the determination methods of the attribute subcategories corresponding to the attribute information of the other information are similar to the above determination method of the attribute subcategory corresponding to the balance, and will not be repeatedly described herein.

Upon completion of the above process, a attribute category corresponding to the attribute information is determined by combining the attribute subcategories corresponding to each attribute information. In specific implementation, attribute subcategories corresponding to each attribute information can be superimposed and combined, and a attribute category corresponding to the attribute information can be determined according to a result of the above superimposing and combining. For example, the first attribute subcategory of the balance and the user attribute subcategory of the recharge frequency in the above example are superimposed and combined, and a result of the superimposing and combining is determined as a first attribute category (that is, the attribute information shall satisfy both the first attribute subcategory of the balance and the first attribute subcategory of the recharge frequency, and at this time, the user behaves correspondingly as high frequency and low price in terms of recharge and consumption characteristics); similarly, the third attribute subcategory of the balance and the second attribute subcategory of the recharge frequency in the above example are superimposed and combined, and a result of the superimposing and combining is determined as a second attribute category (the user behaves as low frequency and high price in terms of recharge and consumption characteristics), and so on. In specific implementation, the specific superimposing and combining manner in the above superimposing and combining process can be set by the skilled person in the art according to actual situations, and the present disclosure does not limit this. Wherein, in order to make the determined attribute category more accurate, in the above process of determining the attribute category, a corresponding weight can also be set for each attribute subcategory, and a corresponding superimposing and combining result can be calculated according to the weight, and the attribute category can be determined according to the calculated superimposing and combining result, so as to improve the accuracy of determining the user attribute type.

Specifically, the plurality of classification of information to be pushed may comprise at least one of a book information classification, a points information classification, a physical item information classification, an electronic coupon information classification, a welfare card information classification, a recharge preferential information classification, an activity information classification, or a reading authority information classification. In this step, an information classification matching the attribute category can be determined based on a first predetermined mapping table, wherein the first predetermined mapping table stores a corresponding relationship between each attribute category and each classification of information. For example, when the determined attribute category is the first attribute category (corresponding to high-frequency and low-price users), if the first predetermined mapping table is that the first attribute category corresponds to the first information classification (corresponding to the push information category of high-frequency and low-price users), the information classification matching the first attribute category is determined as the first information category. In specific implementation, the determination manners of the other user attribute categories and the information classification corresponding thereto are similar to the above manner, and will not be repeatedly described herein. Wherein, the first predetermined mapping table can be set by those skilled person in the art according to actual situations, and the present disclosure does not limit this.

Step S230: Analyze a range of the attribute data, and determine content corresponding to the range of the attribute data based on a second predetermined mapping table, wherein the second predetermined mapping table is configured to store a plurality of contents contained in each classification of information and a range of attribute data corresponding to each content among the plurality of contents contained in each classification of information.

In this step, the attribute information in each user attribute category and the information content in each information classification are classified in more detail. Specifically, for the attribute information in each attribute category, a range of the user attribute data is analyzed. Wherein, the specific analysis manner of the above analysis process and the specific delimited range of the above data range can be set by those skilled person in the art according to actual situations, and the present disclosure does not limit this. In the second predetermined mapping table, a corresponding relationship between a range of the attribute data and a plurality of contents contained in the information classification matching the attribute category is preset. In this step, after the attribute category is determined, the range of the attribute data is first analyzed and determined, and then information content corresponding to the range is looked up and determined by the second predetermined mapping table, to refine the corresponding relationship between the attribute data and the content which has been pushed, so that when the content is pushed in subsequent processes, the pushed content is more accurated and customized when orientating to the user, making the content pushing more effective.

For example, taking the example in step S220 as an example, after it is determined that the first attribute category corresponds to the first information classification, the range of the attribute data is further analyzed. If there are two ranges for the attribute data in the second predetermined mapping table, which are a first data range corresponding to the first content and a second range corresponding to the second content, respectively, then when the first range of the attribute data contained in the attribute information of the first attribute category obtained is analyzed, content corresponding to the range is determined as the first content according to the second predetermined mapping table; similarly, when the second range of the attribute data contained in the attribute information of the second attribute category obtained is analyzed, i content corresponding to the range is determined as the second content according to the second predetermined mapping table.

In addition, optionally, the attribute data may also be stored locally, for example, books stored locally by a user. Accordingly, when the range of the attribute data is analyzed, the attribute data stored locally by the user can also be searched and acquired firstly, and a range of the acquired local attribute data can be further analyzed. For example, after the electronic books stored locally by the user are analyzed, if an analysis result indicates that the number of romance books in the electronics books stored locally by the user accounts for more than 50% of the total number of the local books, the range of the attribute data is determined as a romance category, and then content corresponding to the romance category is searched in the second predetermined mapping table, to push romance-related content to the user.

In addition, when the content corresponding to the range is determined, ranges of different attribute data can also be superimposed and combined, and the corresponding content can be determined according to a result of the superimposing and combining. Wherein, the above process of superimposing and combining is similar to the superimposing process in step S220, and will not be repeatedly described herein. Moreover, in the above superimposing process, it can also set a corresponding weight for each attribute data according to the importance of the attribute data, and then to calculate and analyze the range of the attribute data according to the weight, so as to make the range obtained from the analysis more accurate, so that the determined corresponding content is also more definite, and the accuracy of pushing content is improved.

Step S240: Push the content to a user terminal device corresponding to the user identification.

Specifically, in this step, the content determined in step S230 is pushed to the user terminal device corresponding to the user identification.

In the method for pushing information provided by the present disclosure, it can determine attribute information associated with a user based on acquiring a user identification, to further determine an attribute category corresponding to the attribute information, and determine a classification of information among a plurality of classifications of information to be pushed based on the attribute category, then to analyze attribute data included in the attribute information and obtain an analysis result, and determine a content among a plurality of contents included in the classification of information based on the analysis result, wherein the content matches the analysis result, and finally to push the content to a user terminal device corresponding to the user identification. Accordingly, the present disclosure can effectively classify users and content, and further establish a corresponding relationship between the classified users and content, so as to push a classification of information to a user who matches the classification of information, so that the information pushing is more accurate and customized to the user, thus ensuring the content pushed to the user to meet the user's current needs, and making the information pushing more effective.

In order to facilitate understanding, in conjunction with the embodiment shown in FIG. 2, exemplary illustration is made by taking a scenario where the user account balance is insufficient as an example:

Through step S210, attribute information corresponding to an acquired user identification is determined. This example uses the balance as the attribute information for illustration. In practical applications, the attribute information may be considered in a plurality of information.

Through step S220, when the attribute information is a balance, if the balance is low, the corresponding attribute category is determined as an balance-insufficient category, and an information classification matching the balance-insufficient is determined as a voucher category from a plurality of classification of information to be pushed.

Through step S230, according to the specific amount of the balance, a corresponding voucher amount is determined from a plurality of voucher amounts contained in the voucher category according to a preset information content mapping table. Specifically, a lower user's balance indicates that the user needs a larger amount of voucher; for example, when the user's balance is less than 2 Yuan, the corresponding voucher amount is 5 Yuan; and when the user's balance is less than 10 Yuan, the corresponding voucher amount is 3 Yuan.

Through step S240, the voucher is pushed to the user terminal device.

Through the above steps, the process of judging that the user needs a voucher and thereby pushing the voucher to the user when the user's balance is insufficient can be realized. In a practical application, the voucher can be pushed to the user through a turntable lottery. The specific process is as follows: the user triggers the turntable lottery, the system judges that the user's current balance is insufficient and thus displays the voucher category as a candidate award on the turntable; after the user turns the turntable to complete the turntable lottery, the voucher category will be hit, and the voucher category is clicked after being hit, which shows the specific voucher amount. The process of using the voucher category as the candidate award does not need to query the preset information content mapping table, which can save time and improve the speed of determining the candidate award. On the other hand, during the turn of the turntable, the preset information content mapping table can be queried according to the user's current balance, to determine the voucher amount. By using this method, a better voucher amount can be determined to ensure better pushing accuracy, and also, the time required for the processing process therein will not let the user feel it, which can improve the user experience.

### Embodiment 3

Embodiment 3 of the present disclosure provides a non-transitory computer-readable storage medium having stored thereon at least one executable instruction. The computer-executable instruction can execute the method for pushing information in any of the foregoing method embodiments.

The executable instruction specifically may be used to cause a processor to perform the operations of:

determining attribute information associated with a user based on acquiring a user identification; determining an attribute category corresponding to the attribute information, and determining a classification of information among a plurality of classifications of information to be pushed based on the attribute category, wherein the classification of information matches the attribute category; analyzing attribute data included in the attribute information and obtaining an analysis result, and determining a content among a plurality of contents included in the classification of information based on the analysis result, wherein the content matches the analysis result; and pushing the content to a user terminal device corresponding to the user identification.

In an optional manner, the attribute information includes at least one of a balance, a recharge frequency, a recharge amount, a consumption frequency, a consumption amount, a reading duration, a number of participation in activities, or information content that has been pushed.

In an optional manner, when the attribute information includes a plurality of types of information, the operations further comprise: determining an attribute subcategory corresponding to each of the plurality of types of information; and determining the attribute category corresponding to the attribute information by combining each attribute subcategory corresponding to each of the plurality of types of information.

In an optional manner, the plurality of classifications of information to be pushed comprise at least one of a book information classification, a points information classification, a physical item information classification, an electronic coupon information classification, a welfare card information classification, a recharge preferential information classification, an activity information classification, or a reading authority information classification; and wherein the operations further comprise determining the classification of information that matches the attribute category based on a first predetermined mapping table, wherein the first predetermined mapping table stores a corresponding relationship between each attribute category and each classification of information.

In an optional manner, the executable instruction further causes the processor to perform the operation of: determining a range of the attribute data and determining the content corresponding to the range of the attribute data based on a second predetermined mapping table; wherein the second predetermined mapping table is configured to store a plurality of contents contained in each classification of information and a range of attribute data corresponding to each content among the plurality of contents contained in each classification of information.

In an optional manner, when the attribute information includes a plurality of types of information, the operations further comprising: determining a range of attribute data contained in each of the plurality of types of information; and determining the content based on the range of attribute data contained in each of the plurality of types of information and a weight corresponding to each of the plurality of types of information.

In an optional manner, the executable instruction further causes the processor to perform at least one of the following operations:

Operation 1: in response to receiving a request for pushing messages, acquiring the user identification included in the request for pushing messages and determining the attribute information corresponding to the user identification, wherein the request for pushing messages is trigger by the user via a preset interface;

Operation 2: in response to determining a behavior of the user meets a predetermined condition for pushing information, acquiring the user identification and determining the attribute information corresponding to the user identification, wherein the predetermined condition comprises at least one of a user reading up to a chapter of an electronic book with a reading abandonment probability greater than a predetermined threshold, a user reading duration exceeding a predetermined reading duration, or a user reading a chapter reaching a predetermined chapter.

### Embodiment 4

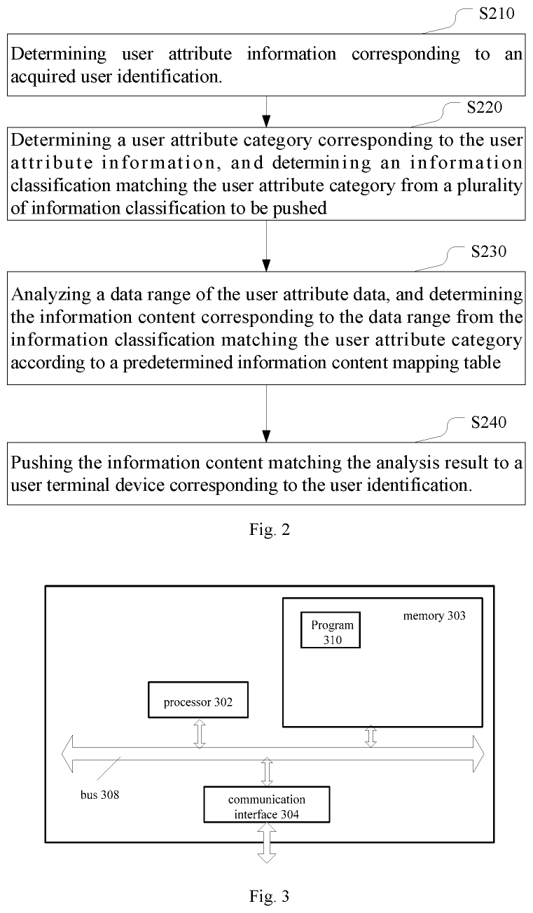

FIG. 3 shows a structural schematic diagram of an electronic device according to Embodiment 4 of the present disclosure. Specific embodiments of the present disclosure do not limit the implementation of the electronic device.

As shown in FIG. 3, the electronic device may comprise a processor 302, a communications interface 304, a memory 306, and a communications bus 308.

Wherein: the processor 302, the communications interface 304 and the memory 36 implement communication with each other through the communications bus 308. The communications interface 304 is configured to communicate with network elements of other devices, such as a client or another server or the like. The processor 302 is configured to execute a program 310, and specifically may perform related steps in the foregoing method for pushing information.

Specifically, the program 310 may comprise program code, which comprises a computer operation instruction.

The processor 302 may be a central processing unit CPU, or an application specific integrated circuit ASIC, or one or more integrated circuits configured to implement the embodiments of the present disclosure. The one or more processors included in the electronic device may be processors of the same type, such as one or more CPUs, and may also be processors of different types, such as one or more CPUs and one or more ASICs.

The memory 306 is configured to store the program 310. The memory 306 may include a high-speed RAM memory, and may also include a non-volatile memory, for example, at least one disk memory.

The program 310 specifically may be configured to cause the processor 302 to perform the following operations:

determining attribute information associated with a user based on acquiring a user identification;

determining an attribute category corresponding to the attribute information, and determining a classification of information among a plurality of classifications of information to be pushed based on the attribute category, wherein the classification of information matches the attribute category;

analyzing attribute data included in the attribute information and obtaining an analysis result, and determining a content among a plurality of contents included in the classification of information based on the analysis result, wherein the content matches the analysis result; and

pushing the content to a user terminal device corresponding to the user identification.

In an optional manner, the attribute information includes information associated with at least one of a balance, a recharge frequency, a recharge amount, a consumption frequency, a consumption amount, a reading duration, a number of participation in activities, or information content that has been pushed.

In an optional manner, when the attribute information comprises a plurality of information, the program 310 further causes the processor 302 to perform the operations of: determining an attribute subcategory corresponding to each of the plurality of types of information; and determining the attribute category corresponding to the attribute information by combining each attribute subcategory corresponding to each of the plurality of types of information.

In an optional manner, the plurality of classifications of information to be pushed comprise at least one of a book information classification, a points information classification, a physical item information classification, an electronic coupon information classification, a welfare card information classification, a recharge preferential information classification, an activity information classification, or a reading authority information classification; and; and the program 310 further causes the processor 302 to perform the operation of: determining the classification of information that matches the attribute category based on a first predetermined mapping table, wherein the first predetermined mapping table stores a corresponding relationship between each attribute category and each classification of information.

In an optional manner, the program 310 further causes the processor 302 to perform the operation of: determining a range of the attribute data and determining the content corresponding to the range of the attribute data based on a second predetermined mapping table; wherein the second predetermined mapping table is configured to store a plurality of contents contained in each classification of information and a range of attribute data corresponding to each content among the plurality of contents contained in each classification of information.

In an optional manner, when the attribute information includes a plurality of types of information, the program 310 further causes the processor 302 to perform the operations of:

determining a range of attribute data contained in each of the plurality of types of information; and determining the content based on the range of attribute data contained in each of the plurality of types of information and a weight corresponding to each of the plurality of types of information.

In an optional manner, the program 310 further causes the processor 302 to perform at least one of the following operations:

Operation 1: in response to receiving a request for pushing messages, acquiring the user identification included in the request for pushing messages and determining the attribute information corresponding to the user identification, wherein the request for pushing messages is trigger by the user via a preset interface;

Operation 2: in response to determining a behavior of the user meets a predetermined condition for pushing information, acquiring the user identification and determining the attribute information corresponding to the user identification, wherein the predetermined condition comprises at least one of a user reading up to a chapter of an electronic book with a reading abandonment probability greater than a predetermined threshold, a user reading duration exceeding a predetermined reading duration, or a user reading a chapter reaching a predetermined chapter.

The algorithms and displays provided herein are not inherently related to any specific computer, virtual system or other devices. Various general-purpose systems can also be used together with the teaching based on this. From the above description, the structure required to construct such a system is obvious. Moreover, the present disclosure is not directed to any specific programming language, either. It should be appreciated that the content of the present disclosure described herein may be implemented using a variety of programming languages, and that the above description of the specific language aims to disclose the best embodiment of the present disclosure.

In the specification provided herein, numerous specific details have been explained. However, it can be understood that embodiments of the present disclosure may be practiced without these specific details. In some instances, well-known methods, structures, and techniques have not been shown in detail, so as not to obscure the understanding of the specification.

Similarly, it should be understood that, in order to simplify the present disclosure and help understand one or more of the various disclosed aspects, in the above description of exemplary embodiments of the present disclosure, various features of the present disclosure are sometimes grouped together into a single embodiment, figure, or description thereof. However, this disclosed method should not be construed as reflecting the intention that the claimed present disclosure claims more features than those expressly recited in each claim. Rather, as reflected in the following claims, the disclosed aspect is less than all features of the single embodiment disclosed previously. Thus, the claims following a specific embodiment are hereby expressly incorporated into that specific embodiment, with each claim standing on its own as a separate embodiment of the present disclosure.

Those skilled in the art can understand that the modules in the device in the embodiment may be adaptively changed and be arranged in one or more devices different from this embodiment. The modules or units or components in the embodiment may be combined into one module or unit or component, and furthermore, they may be divided into a plurality of sub-modules or sub-units or sub-components. Except for at least some of such features or processes or units being mutually exclusive, all features disclosed in this specification (including the accompanying claims, abstract and drawings) and all processes or units of any method or device so disclosed may be combined by adopting any combination. Each feature disclosed in this specification (including the accompanying claims, abstract, and drawings) may be substituted by alternative features serving the same, equivalent or similar purpose, unless expressly stated otherwise.

In addition, those skilled in the art can understand that although some embodiments described herein include some features included in other embodiments but not other features, the combination of features of different embodiments is meant to be within the scope of the present disclosure and forms different embodiments. For example, in the following claims, any one of the claimed embodiments may be used in any combination.

It should be noted that the above-mentioned embodiments illustrate rather than limit the present disclosure, and that those skilled in the art may design alternative embodiments without departing from the scope of the appended claims. In the claims, any reference signs placed between parentheses shall not be construed as limiting the claims. The word “comprising” does not exclude the presence of elements or steps not listed in a claim. The word “a” or “an” preceding an element does not exclude the presence of a plurality of such elements. The present disclosure may be implemented by means of hardware comprising several distinct elements, and by means of a suitably programmed computer. In the unit claim listing several devices, several of these devices may be embodied by the same hardware item. The use of the words first, second, third and the like does not imply any order. These words can be interpreted as names.

1. A method for pushing information, comprising:
determining attribute information associated with a user based on acquiring a user identification;
determining an attribute category corresponding to the attribute information, and determining a classification of information among a plurality of classifications of information to be pushed based on the attribute category, wherein the classification of information matches the attribute category;
analyzing attribute data included in the attribute information and obtaining an analysis result, and determining a content among a plurality of contents included in the classification of information based on the analysis result, wherein the content matches the analysis result; and
pushing the content to a user terminal device corresponding to the user identification.

2. The method according to claim 1, wherein the attribute information includes information associated with at least one of a balance, a recharge frequency, a recharge amount, a consumption frequency, a consumption amount, a reading duration, a number of participation in activities, or information content that has been pushed.

3. The method according to claim 2, wherein when the attribute information includes a plurality of types of information, the determining an attribute category corresponding to the attribute information further comprises:
determining an attribute subcategory corresponding to each of the plurality of types of information; and
determining the attribute category corresponding to the attribute information by combining each attribute subcategory corresponding to each of the plurality of types of information.

4. The method according to claim 1,
wherein the plurality of classifications of information to be pushed comprise at least one of a book information classification, a points information classification, a physical item information classification, an electronic coupon information classification, a welfare card information classification, a recharge preferential information classification, an activity information classification, or a reading authority information classification; and
wherein the determining the classification of information among the plurality of classifications of information to be pushed based on the attribute category further comprises determining the classification of information that matches the attribute category based on a first predetermined mapping table, wherein the first predetermined mapping table stores a corresponding relationship between each attribute category and each classification of information.

5. The method according to claim 1, wherein the analyzing attribute data included in the attribute information and obtaining an analysis result and determining a content among a plurality of contents included in the classification of information based on the analysis result further comprises:
determining a range of the attribute data and determining the content corresponding to the range of the attribute data based on a second predetermined mapping table, wherein the second predetermined mapping table is configured to store a plurality of contents contained in each classification of information and a range of attribute data corresponding to each content among the plurality of contents contained in each classification of information.

6. The method according to claim 5, wherein when the attribute information includes a plurality of types of information, the determining a range of the attribute data and determining the content corresponding to the range of the attribute data based on a second predetermined mapping table further comprises:
determining a range of attribute data contained in each of the plurality of types of information; and
determining the content based on the range of attribute data contained in each of the plurality of types of information and a weight corresponding to each of the plurality of types of information.

7. The method according to claim 1, wherein the determining attribute information associated with a user based on acquiring a user identification further comprises at least one of:
in response to receiving a request for pushing messages, acquiring the user identification included in the request for pushing messages and determining the attribute information corresponding to the user identification, wherein the request for pushing messages is trigger by the user via a preset interface;
in response to determining a behavior of the user meets a predetermined condition for pushing information, acquiring the user identification and determining the attribute information corresponding to the user identification, wherein the predetermined condition comprises at least one of a user reading up to a chapter of an electronic book with a reading abandonment probability greater than a predetermined threshold, a user reading duration exceeding a predetermined reading duration, or a user reading a chapter reaching a predetermined chapter.

8. An electronic device, comprising:
at least one processor; and
at least one memory, the at least one memory storing executable instructions that upon execution cause the at least one processor to perform operations, the operations comprising:
determining attribute information associated with a user based on acquiring a user identification;
determining an attribute category corresponding to the attribute information, and determining a classification of information among a plurality of classifications of information to be pushed based on the attribute category, wherein the classification of information matches the attribute category;
analyzing attribute data included in the attribute information and obtaining an analysis result, and determining a content among a plurality of contents included in the classification of information based on the analysis result, wherein the content matches the analysis result; and
pushing the content to a user terminal device corresponding to the user identification.

9. The electronic device according to claim 8, wherein the attribute information includes information associated with at least one of a balance, a recharge frequency, a recharge amount, a consumption frequency, a consumption amount, a reading duration, a number of participation in activities, or information content that has been pushed.

10. The electronic device according to claim 9, wherein when the attribute information includes a plurality of types of information, the operations further comprising:
determining an attribute subcategory corresponding to each of the plurality of types of information; and
determining the attribute category corresponding to the attribute information by combining each attribute subcategory corresponding to each of the plurality of types of information.

11. The electronic device according to claim 8,
wherein the plurality of classifications of information to be pushed comprise at least one of a book information classification, a points information classification, a physical item information classification, an electronic coupon information classification, a welfare card information classification, a recharge preferential information classification, an activity information classification, or a reading authority information classification; and
wherein the operations further comprise determining the classification of information that matches the attribute category based on a first predetermined mapping table, wherein the first predetermined mapping table stores a corresponding relationship between each attribute category and each classification of information.

12. The electronic device according to claim 8, wherein the operations further comprising:
determining a range of the attribute data and determining the content corresponding to the range of the attribute data based on a second predetermined mapping table;
wherein the second predetermined mapping table is configured to store a plurality of contents contained in each classification of information and a range of attribute data corresponding to each content among the plurality of contents contained in each classification of information.

13. The electronic device according to claim 12, wherein when the attribute information includes a plurality of types of information, the operations further comprising:
determining a range of attribute data contained in each of the plurality of types of information; and
determining the content based on the range of attribute data contained in each of the plurality of types of information and a weight corresponding to each of the plurality of types of information.

14. The electronic device according to claim 8, the operations further comprising at least one of:
in response to receiving a request for pushing messages, acquiring the user identification included in the request for pushing messages and determining the attribute information corresponding to the user identification, wherein the request for pushing messages is trigger by the user via a preset interface;
in response to determining a behavior of the user meets a predetermined condition for pushing information, acquiring the user identification and determining the attribute information corresponding to the user identification, wherein the predetermined condition comprises at least one of a user reading up to a chapter of an electronic book with a reading abandonment probability greater than a predetermined threshold, a user reading duration exceeding a predetermined reading duration, or a user reading a chapter reaching a predetermined chapter.

15. A non-transitory computer-readable storage medium, storing computer-readable instructions that upon execution by a processor cause the processor to:
determine attribute information associated with a user based on acquiring a user identification;
determine an attribute category corresponding to the attribute information, and determine a classification of information among a plurality of classifications of information to be pushed based on the attribute category, wherein the classification of information matches the attribute category;
analyze attribute data included in the attribute information and obtain an analysis result, and determine a content among a plurality of contents included in the classification of information based on the analysis result, wherein the content matches the analysis result; and
push the content to a user terminal device corresponding to the user identification.

16. (canceled)
